(19) United States
(12) Patent Application Publication
(10) Pub. No.: US 2021/0170349 A1
(43) Pub. Date: Jun. 10, 2021

(54) Diluting, Mixing and/or Aliquoting Two Fluids in a Microfluidic System

(71) Applicant: Robert Bosch GmbH, Stuttgart (DE)

(72) Inventors: Jochen Hoffmann, Renningen (DE); Tino Frank, Luzern (CH)

(21) Appl. No.: 17/048,093

(22) PCT Filed: Apr. 9, 2019
(86) PCT No.: PCT/EP2019/058900

§ 371 Date: Oct. 15, 2020

(30) Foreign Application Priority Data
Apr. 26, 2018 (DE) 10 2018 206 463.6

(51) Int. Cl. B01F 5/10; B01F 3/08; B01F 13/00; B01F 15/04; B01L 3/00

(52) U.S. Cl. CPC B01F 5/102; B01F 3/0861; B01F 13/0083; B01L 2400/0475; B01L 3/502715; B01L 3/50273; B01F 15/0454

(57) ABSTRACT

A method for diluting, mixing, and/or aliquoting two liquids using a microfluidic system with at least two pump chambers first includes filling at least one of the at least two pump chambers with a first liquid. The at least two pump chambers are connected to one another by at least one microfluidic channel. The method then includes pumping the first liquid through the channel. The at least one channel is configured such that at least part of the first liquid remains in the channel after the pumping. The method then includes determining the part of the first liquid that remains in the channel. The method then includes flushing the channel with a second liquid.

The present invention relates to a method of diluting, mixing and/or aliquoting two fluids in a microfluidic system having at least two sample chambers and at least one channel.

### STATE OF THE ART

Microfluidic devices or systems, for example microfluidic chips, are used for various fields of application. Such fluidic devices, generally made from plastic, may be used, for example, for analytical, preparative or diagnostic applications, especially in medicine, and serve for analysis of sample solutions with high sensitivity in miniaturized form. The microfluidic systems permit automation and parallelization of the process steps performed. The microfluidic systems may be used, for example, in the form of a lab-on-chip system, wherein the functionalities of a laboratory are effectively combined in the format of a bank card. The miniaturization allows laboratory processes to be conducted directly on taking of the sample at the point of care.

In order to be able to perform various processes, a frequent operation is dilution, mixing and/or aliquoting of fluids and division into different volumes. Conventionally, the dilution, mixing and/or aliquoting, i.e. the ascertaining of proportions, are implemented by means of a fixed geometry of the microfluidic system.

### DISCLOSURE OF THE INVENTION

The invention also relates to a method of diluting, mixing and/or aliquoting two fluids using a microfluidic system comprising at least two pump chambers connected to one another by at least one microfluidic channel (called “channel” for short hereinafter). The pump chambers each have an inlet and an outlet, via which the pump chambers can be filled or emptied with fluid, wherein the outlet of one pump chamber is connected via the microfluidic channel to the inlet of a further pump chamber. At least one of the pump chambers is set up to pump a first fluid with which this chamber has been filled through the at least one first channel into another chamber. For this purpose, the pump chamber (“chamber” for short hereinafter) may have a membrane which is deflected in the pumping operation and displaces the fluid from the chamber. The first fluid is especially an aqueous solution comprising an analyte to be analyzed.

In a first step, at least one of the chambers is filled with a first fluid. The first fluid is especially a sample solution to be analyzed. Thereafter, the first fluid is pumped through the channel to a further chamber. On account of the configuration of the channel, a portion of the first fluid remains in the channel. After the pumping, the channel is preferably filled completely with the first fluid. The portion of the first fluid remaining in the channel is dependent on the configuration of the channel, especially on the geometry, shape and length thereof. The choice of channel can define the volume of the portion of the first fluid that remains in the channel. The portion of the first fluid that remains in the channel is subsequently ascertained. Purely in principle, this ascertaining can be implemented by means of additional components. Preferably, however, the known geometry, shape and length of the channel are used for this purpose, and these are used to conclude the volume of the portion of the first fluid remaining in the channel.

The same channel in which the portion of the first fluid is present is purged with a second fluid, such that the first fluid and the second fluid mix. What is meant by purging in this connection is that the second fluid flows through the microfluidic system and, in so doing, more particularly through the channel. The second fluid here may be kept in one of the further chambers and then pumped into the system. Particularly suitable for this purpose are closed circuits in which the outlet of each of the chambers is connected to an inlet of one of the further chambers. This is referred to as cyclical mixing. This means that mixing of the two fluids can be achieved by alternating pumping back and forth between the two chambers. Alternatively, the second fluid can be supplied to the microfluidic system via an inlet from the outside. For this purpose, it is possible to use an external device, for example an external pump, disposed outside the microfluidic system described. The volume of the second fluid introduced for purging may be adjusted. The second fluid is especially likewise an aqueous solution. As a result, it is possible in a simple manner to achieve mixing and/or dilution of the two fluids with a defined and controllable volume of the first fluid and a volume, adjustable in the purging operation, of the second fluid. There may optionally follow an aliquoting operation, i.e. ascertaining of the proportions, of the mixture. It is thus possible to achieve a particularly simple passive separation or removal of part of the volume of the first fluid from the total volume. It is particularly advantageous here that the dynamic mixing permits adjustment of the reaction mixture and/or of the dilution level during the experiment. This allows the dilution level to be chosen depending on the total volume of the first fluid present at the outset.

The method can also be used for a microfluidic network consisting of a multitude of pump chambers and a multitude of channels by which the chambers are connected to one another. For this purpose, the abovementioned steps may be repeated. The above-described two pump chambers and the channel that connects the two can be regarded as a module of the microfluidic network. The microfluidic network describes a higher-level structure of the pump chambers and the channels and can be considered as part of the microfluidic system. According to the present aspect, the microfluidic network has a multitude of the modules described at the outset. The individual modules may be configured differently and especially have differently configured channels in which different volumes of the first fluid then remain. As a result, it is possible to establish different mixing ratios and/or dilution levels in a given microfluidic network. This has the advantage that desired dilutions can be established in a defined manner. The microfluidic network may additionally also have other modules, chambers and/or channels. The above-described modules may be inserted into existing microfluidic networks.

The expressions “first” fluid and “second” fluid are intended to serve here merely for distinction of two fluids. In each repetition of the method, the same or other fluids may be chosen as new “first” or “second” fluids, and the invention is not limited to two types of fluids. According to the application, the first fluid with which at least one of the chambers is filled is chosen in accordance with the following options: firstly, the first fluid corresponds to the initial first fluid that has been transferred into these chamber(s) by pumps, minus the portion of the first fluid that has remained in the channel. Secondly, the mixture of the first fluid with the second fluid that has formed after one pass through the method may be regarded as the new first fluid in the repetition of the method. In this way, it is possible to achieve further mixings or dilutions. In both options, in the repetition of the method, the second fluid may correspond to the initial second fluid, or a different second fluid may be chosen. In addition, in the repetition of the method, it is possible to select a different channel through which the first fluid is pumped. As already described, the channels may be different and, consequently, a different volume may remain in the different channels. By the choice of channel, it is possible to achieve different mixing ratios or dilution levels.

Mainly surface effects of the first fluid and the channel are responsible for the fact that the portion of the first fluid remains in the channel after the pumping. The main effects that should be mentioned here are the surface tension of the (first) fluid itself and the interfacial tension between the (first) fluid and the surface of the channel in contact with the (first) fluid. The surface effects preferably lead to a capillary effect of the (first) fluid in the channel. The surface effects mentioned are dependent on the geometry, shape and length of the channel, on the material of the surface of the channel, and on the fluid itself. With regard to the surface effects, the first aqueous fluid can be equated to water, so that these are readily manageable. According to the present aspect, the at least one channel is configured in such a way that the desired portion of the fluid remains in the channel owing to the surface effects after the pumping operation. Preferably, the ratio between the volume of the chamber to be pumped, and therefore of chamber from which the first fluid is pumped into the connecting channel, and the volume of the channel is within a range between 1:2 and 1:10 000, more preferably within a range between 1:5 and 1:1000. These ratios have particularly good suitability to leave a portion of the first fluid in the channel. The volume of the pump chamber is preferably within a range between 1 μl and 500 μl, more preferably within a range between 10 μl and 50 μl. These volumes of the pump chambers have particularly good suitability for typical studies, for example in molecular diagnosis.

As already described, the portion of the first fluid remaining in the channel is ascertained. For this purpose, on the one hand, the volume of the channel can be calculated from the known geometry, shape and length of the channel and this can be used to conclude the volume of the portion of the first fluid remaining in the channel. In the case of complete filling of the channel with the first fluid, the volume of the portion of the first fluid remaining in the channel corresponds specifically to the volume of the channel. The volume of the channel is usually known, for example set in the course of production or ascertained by measurement, and for that reason, in this case, the volume of the channel and the volume of the portion of the first fluid remaining in the channel can be equated. Alternatively, a camera with evaluation unit may be used in order to ascertain the volume of the portion of the first fluid remaining in the channel taking account of the geometry, shape and length of the channel, for which purpose it is possible to ascertain the fill level. Moreover, with the aid of the above-described camera together with the evaluation unit, it is possible to ascertain the dilution level of the fluid. The data ascertained, and therefore the volume and/or mass of the portion of the first fluid, may be used to monitor the attainment of a desired mixing ratio and/or a desired dilution level. Alternatively or additionally, the data ascertained may be used to ascertain the volume of the second fluid which is required to achieve the desired dilution, mixing and/or aliquoting.

In one aspect, the chambers are emptied after the pumping chamber has pumped the first fluid into the other chamber. In this case, it is envisaged that the first fluid remains in the at least one channel even after the chambers have been emptied. Thereafter, the second fluid can be introduced into the microfluidic system through the chambers that have now been emptied. This allows the mixing or the diluting of the first fluid with the second fluid to be implemented in a particularly simple manner. After the emptying, only the first fluid remaining in the channel, the volume of which is known, is present in the microfluidic system. In other words, the second fluid, on purging, can merely mix with the known first fluid in the channel since, after the emptying and before the purging, no further fluid is present in the microfluidic system in question. It should be noted here that, in connection with an above-described microfluidic network, not all pump chambers have to be simultaneously emptied and, nevertheless, further fluid may be present in the microfluidic network—even outside the channels, especially also in the chambers.

The computer program is set up to perform each step of the method, especially when it is performed on a computation unit or control unit. It enables the implementation of the method in a conventional electronic control device without having to make structural alterations thereto. For this purpose, it is stored on the machine-readable storage medium.

By running the computer program on a conventional electronic control device for controlling the microfluidic system, the electronic control device set up to dilute, to mix and/or to aliquot the two fluids using the microfluidic system is obtained.

The electronic control device may be part of a lab-on-chip comprising the above-described microfluidic system. The lab-on-chip also has components for controlling the fluid flow, components for executing laboratory processes and components for evaluation in a compact design. This integrated design allows for analysis of a sample solution entirely in the lab-on-chip. Optionally, the lab-on-chip may have a camera surveying the at least one channel and an evaluation unit that evaluates signals from the camera. The camera detects the fluid in the channel and records, for example, the fluorescence and/or turbidity of the fluid and transmits its signals to the evaluation unit. The evaluation unit uses the camera signals, i.e., for example, the fluorescence and/or turbidity, to ascertain the dilution level of the fluid. In this way, it is possible to monitor the attainment of the desired mixing ratio and/or the desired dilution level. The monitoring of the dilution stage results in a feedback system by means of which the mixing or dilution of the fluid(s) can be controlled under open- or closed-loop control. In addition, the evaluation unit may also ascertain the volume of the portion of the first fluid remaining in the channel.

### BRIEF DESCRIPTION OF THE DRAWINGS

Working examples of the invention are illustrated in the drawings and is elucidated in detail in the description that follows.

FIGS. 1 a-d show schematic diagrams of a first embodiment of the invention.

FIGS. 2 a-f show schematic diagrams of a second embodiment of the invention.

FIGS. 3 a-i show schematic diagrams of a third embodiment of the invention.

FIGS. 4 a-g show schematic diagrams of a fourth embodiment of the invention.

FIG. 5 shows a schematic diagram of a lab-on-chip on which one embodiment of the method of the invention can proceed.

### WORKING EXAMPLES OF THE INVENTION

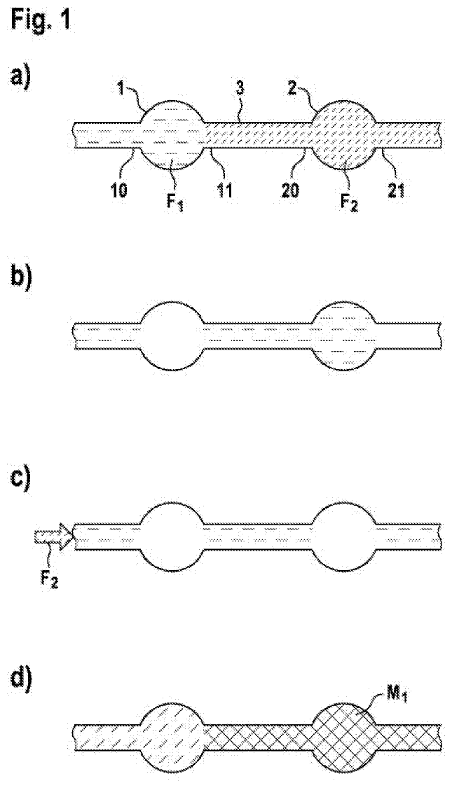

FIGS. 1 a-d show schematic diagrams of a microfluidic system. Elucidated hereinafter is the basic concept of the microfluidic system that can be regarded as an independent module for use in a microfluidic network. The parts of the FIG. 1 a-c each show a step of a first embodiment of the method of the invention. The microfluidic system has a first pump chamber 1 and a second pump chamber 2, which, in this working example, are each of the same construction and each have a membrane (not shown) which is deflected in the course of pumping and displaces a fluid from the respective chamber. In further working examples, the first pump chamber 1 and the second pump chamber may differ in construction, function, volume and the components encompassed. The two chambers 1, 2 are connected to one another via a microfluidic channel 3, wherein the microfluidic channel 3 connects an outlet 11 of the first chamber 1 to an inlet 20 of the second chamber 2. The volume of the pump chambers 1, 2 is, for example, 30 μl, and the ratio between the volume of the pump chambers 1, 2 and the volume of the channel is 1:100. In FIG. 1a, the first chamber 1 has been filled via its inlet 10 with a first fluid F₁ which includes an analyte to be analyzed and is based on water. The second chamber 2 and the channel 3 have been filled with a second fluid F₂.

In FIG. 1b, the membrane of the first chamber 1 is deflected and hence the first fluid F₁ is pumped through the channel 3 into the second chamber 2, and this displaces the second fluid F₂ from the second chamber 2 and the channel 3. The channel 3 is configured such that at least a portion of the first fluid F₁ remains in the channel 3 after the pumping operation. It is surface effects in particular, for example the surface tension of the first fluid F₁ itself and the interfacial tension between the first fluid F₁ and the surface of the channel 3 in contact with the first fluid F₁, that act here on the first fluid F₁ and lead to a capillary effect of the first fluid F₁ in the channel 3, as a result of which this is retained in the channel 3. The surface effects mentioned are dependent on the geometry, shape and length of the channel 3, the material of the surface of the channel 3, and the fluid F₁ itself. In this working example, the channel 3 is filled completely with the first fluid F₁ after the pumping operation.

In FIG. 1c, the second chamber 2 is emptied via its outlet 21, with the first fluid F₁ still remaining in the channel 3 even after the emptying owing to the configuration of the channel 3 and the active surface effects. Subsequently, a second fluid F₂ with which the first fluid F₁ is to be mixed or diluted is introduced into the microfluidic system via the inlet 10 of the first chamber 1 and flushed through the channel 3. In FIG. 1d, the first fluid F₁ and the second fluid F₂ mix to give a first mixture M₁ and the first fluid F₁ is diluted with the second fluid F₂. Since the geometry, shape and length of the channel 3 is known and this was filled completely with the first fluid F₁, it is possible to use these to ascertain the volume of the first fluid, such that the mixing ratio or dilution level can be controlled. Moreover, a the aliquoting, i.e. ascertaining of the proportion of the first fluid F₁ or of the analyte, is envisaged.

In FIGS. 1-4, for reasons of clarity, the representation of valves for control of the fluid flow is dispensed with. Identical components are referred to by the same reference numerals hereinafter, and so repeated description thereof is dispensed with. The designations “first chamber” and “second chamber” are based on their filling with a first fluid F₁ and a second fluid F₂, respectively. Within the parts of the figures, for better clarity, reference numerals for fixed components are included only in the respective parts a of the figures and can be applied to the further parts of the figures.

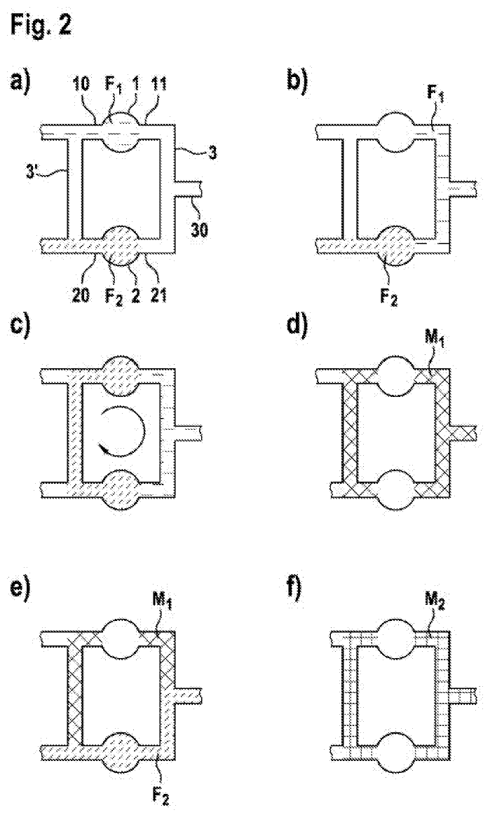

FIGS. 2 a-f show schematic diagrams of a microfluidic system in which the outlet 11 of the first chamber 1 and the outlet 21 of the second chamber 2 are connected via a microfluidic channel 3, and the inlet 10 of the first chamber 1 and the inlet 20 of the second chamber 2 are connected via a further microfluidic channel 3′ of analogous design to the microfluidic channel 3, such that the microfluidic system forms a closed microfluidic circuit. The channel 3 is connected to a common outlet 30. By means of the inlets 10, 20 and the common outlet 30, the above-described module can be incorporated into a microfluidic network. The chambers 1, 2, inlets 10, 20, and the common outlet 30 may be actuated individually.

The parts of the FIGS. 2 a-f each show a step of a second embodiment of the method of the invention. In FIG. 2a, the first chamber 1 has been filled with a first fluid F₁, and a second fluid F₂ is being held in the second chamber 2. In FIG. 2b, the first fluid F₁ is pumped out of the first chamber 1 into the channel 3′ and through the outlet 30. As described above, a portion of the first fluid F₁ remains in the channel 3. In FIG. 2c, the two chambers 1, 2 are alternately opened and closed while pumping, such that the second fluid F₂ moves through the channels 3, 3′ in a closed circuit and mixes with the first fluid F₁ that has remained in the channel 3. This operation is referred to as cyclical mixing. After a defined number of cycles, the two fluids F₁ and F₂, as shown in FIG. 2d, are mixed completely to give a mixture M₁ with a defined mixing ratio, and the chambers 1, 2 are closed. The mixture M₁ can then be used for further analysis purposes. FIGS. 2e and 2f show how a further mixture M₂ with a different mixing ratio is produced from the mixture M₁. Similarly to the first fluid F₁, a portion of the first mixture M₁ also remains in the channels 3, 3′. The second chamber 2 is filled again with the second fluid F₂ via the inlet 20. In other working examples, depending on the desired mixing ratio, the first chamber 1 may instead be filled with the second fluid F₂, or either the first chamber 1 or the second chamber 2 may be filled with the first fluid F₁. This is in turn followed by the cyclical mixing of the second fluid F₂ with the first mixture M₁ which have been mixed completely to give the second mixture M₂ after a defined number of cycles in FIG. 2f.

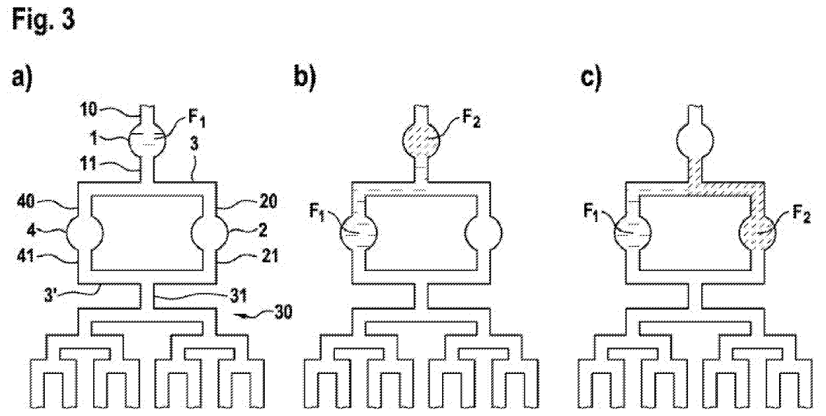

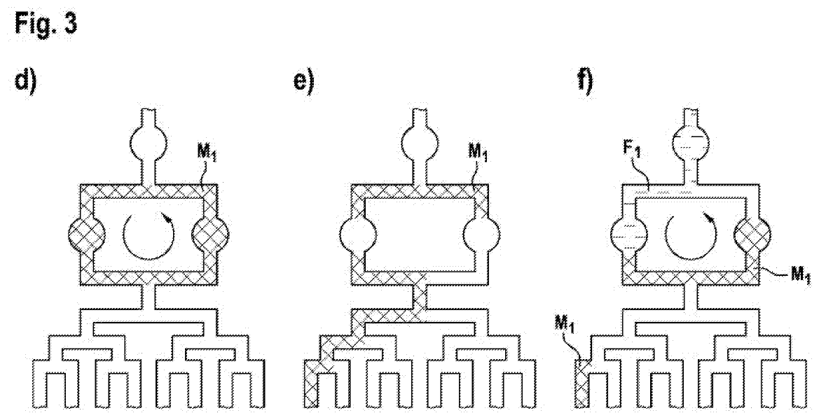

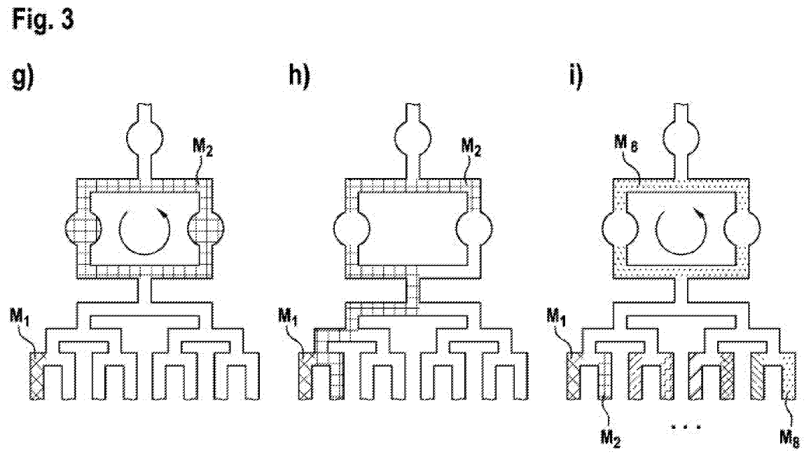

FIGS. 3 a-i show schematic diagrams of a microfluidic network with which dilution series with different dilution levels and mixing ratios can be achieved. The outlet from the first chamber 1 is connected via the microfluidic channel 3 simultaneously to the inlet 20 of the second chamber 2 and an inlet 40 of a third chamber 4. The outlet 21 of the second chamber 2 is connected via a further microfluidic channel 3′ of analogous design to the microfluidic channel 3 to an outlet 41 of the third chamber 4. The further channel 3′ has a common outlet 30 and branches repeatedly and hence forms a network. Each branch of the common outlet 30 and the chambers 1, 2, 4 may be actuated individually by means of the valves described at the outset. At the point in the common outlet 30 identified by reference numeral 31 is disposed a bypass (not shown in detail). This bypass can likewise be used to purge at least the common outlet 30.

The parts of the FIGS. 3 a-i each represent a step of a third embodiment of the method of the invention. In FIG. 3a, the first chamber 1 has been filled with the first fluid F₁ which, in FIG. 1b, is pumped through the channel 3 into the third chamber 4, leaving a portion of the first fluid F₁ in the channel. The chamber 1 is filled with the second fluid F₂ and the latter is subsequently, as shown in FIG. 3c, pumped into the second chamber 2, here too leaving a portion of the second fluid F₂ in the channel. In FIG. 3d, the second fluid F₂ is cyclically mixed with the first fluid F₁, as already elucidated in connection with FIG. 2c, which affords a first mixture M₁ having a defined mixing ratio and a defined dilution level. The first mixture M₁ is, as shown in FIG. 3e, diverted into one of the branches by the outlet 30 and can then be used further. Subsequently, the common outlet 30 is purged via the abovementioned bypass, such that the first mixture M₁, apart from a negligibly small portion, is removed from the common outlet 30. FIG. 3f combines multiple steps. A portion of the first mixture M₁ remains here in the channel 3′, and this is then pumped into the second chamber 2. Moreover, the first chamber 1, in analogy to FIG. 3a, is filled again with the first fluid F₁, and the first fluid F₁, in analogy to FIG. 3b, is then pumped again into the third chamber 4. Depending on the desired mixing ratio and the dilution level, in further working examples, the second fluid F₂ can be used instead. In FIG. 3g, the first mixture M₁ is again cyclically mixed with the first fluid F₁ in order to obtain a second mixture M₂. This second mixture M₂ is then, as shown in FIG. 3h, diverted into a further branch by the outlet 30. The aforementioned steps are repeated in order to obtain the dilution series, shown in FIG. 3i, with eight different mixtures M₁, . . . M₈ that each have a different mixing ratio and different dilution levels.

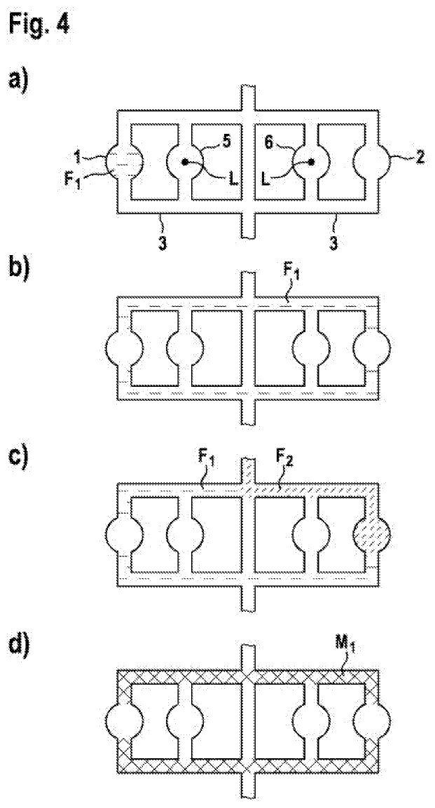

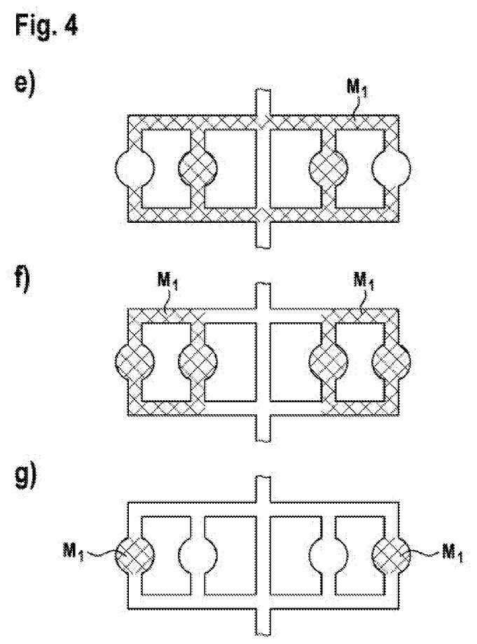

FIGS. 4 a-g show schematic diagrams of a microfluidic system for performance of a nested PCR (polymerase chain reaction). The intention here is to divide a pre-amplicon into two different reaction strands and to dilute primers of the pre-amplicon to such a degree that they are no longer active in a second PCR. The first chamber 1 and second chamber 2 already described are each assigned a further chamber 5, 6 in which there are lyophilizates L, also called lyobeads. The chambers 1, 2, 5, 6 are connected to one another via microfluidic channels 3. The first chamber 1 and the second chamber 2 together form a circuit. In addition, the first chamber 1 with its accompanying chamber 5 and the second chamber 2 with its accompanying chamber 6 each form a sub-circuit. In order to be able to achieve what is called shuttle PCR, the first chamber 1 and the second chamber 2 may be assigned further chambers that are not shown in further working examples, such that three chambers in each case form a unit.

The parts of the FIGS. 4 a-g each show a step of a fourth embodiment of the method of the invention. At the start, in FIG. 4a, the first chamber 1 is filled, for example, with the reaction product of a pre-amplification as first fluid F₁. The first fluid F₁ is then, in FIG. 4b, pumped through the circuit between the first chamber 1 and the second chamber 2. A portion of the first fluid F₁ remains in the channel 3. Subsequently, the microfluidic system is purged with an aqueous second fluid F₂, as shown in FIG. 4c. The first fluid F₁, i.e. the pre-amplicon, and the second fluid F₂, i.e. the buffer, are then, as shown in FIG. 4d, mixed by pumping the first chamber 1 and the second chamber 2 in circulation, giving rise to a mixture M₁. The dilution level can be adjusted by repeating the steps as described in connection with FIG. 3. If the desired dilution level has been attained, the mixture M₁ is pumped into the chambers 5 and 6—see FIG. 4e. By pumping the mixture M₁ in the sub-circuit between the first chamber 1 and the associated chamber 5, and in the sub-circuit between the second chamber 2 and the associated chamber 6, the lyophilizates L present therein are dissolved in the mixture M₁—see FIG. 4f. The mixed product obtained is then, as shown in FIG. 4g, pumped into the first chamber 1 and into the second chamber. Subsequently, the second, specific PCR is started.

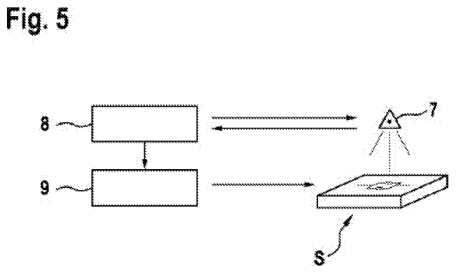

FIG. 5 shows a schematic diagram of a lab-on-chip with a feedback system on which one embodiment of the method of the invention can proceed. The microfluidic system S is surveyed by a camera 7 that records the fluorescence and/or turbidity of the fluid. Additionally provided is an evaluation unit 8 that receives the camera signals. The evaluation unit 8 uses an algorithm to ascertain the dilution level and/or the mixing ratio of the fluids F₁, F₂ from the camera signals. The above-described steps for altering the dilution level are repeated until the desired dilution or the desired mixing ratio has been attained and recognized by the evaluation unit 8. Then the evaluation unit 7 transmits an approval signal to a pneumatic control unit 9 that controls the microfluidic system S and triggers further steps, for example the onward conduction of the mixture obtained. In addition, the evaluation unit 8 ascertains the volume of the second fluid F₂ required for the desired dilution, mixing and/or aliquoting. Firstly, the evaluation unit 8 can compare the dilution level with pre-calibrated dilution levels. Secondly, the evaluation unit 8 can be calibrated during the analysis. The volume of the portion of the first fluid F₁ remaining in the channel 3 is ascertained from the geometry, shape and length of the channel 3, and the volume of the second fluid F₂ is either measured externally or likewise ascertained via the portion remaining in the channel 3. The evaluation unit 8 uses the two volumes of the two fluids F₁ and F₂ to calculate the dilution level or the mixing ratio, and associates them with the camera signals. Thirdly, a reference fluid with known dilution level or mixing ratio can be introduced into the second chamber 2. Then the evaluation unit 8 compares the mixture of the two fluids F₁ and F₂ with the reference fluid. In addition, the evaluation unit 8 can record the dilution levels or mixing ratios, which can then be incorporated into an analysis algorithm of a corresponding assay.

1. A method of diluting, mixing and/or aliquoting two fluids using a microfluidic system with at least two pump chambers connected to one another by at least one microfluidic channel, the at least one channel configured such that at least a portion of the first fluid remains in the channel after a pumping operation, the method comprising:
filling at least one of the at least two pump chambers with a first fluid;
pumping the first fluid through the channel, leaving a portion of the first fluid in the channel;
ascertaining the portion of the first fluid remaining in the channel; and
purging the channel with a second fluid.

2. The method as claimed in claim 1, wherein the portion of the first fluid remaining in the channel is ascertained in order to monitor the attainment of one or more of a desired mixing ratio and a desired dilution level.

3. The method as claimed in claim 1, wherein the portion of the first fluid remaining in the channel is ascertained in order to ascertain a volume of the second fluid required for the desired dilution, mixing, and/or aliquoting.

4. The method as claimed in claim 1, wherein the portion of the first fluid remaining in the channel is ascertained from a volume of the channel.

5. The method as claimed in claim 1, wherein the portion of the first fluid remaining in the channel is ascertained by signals from a camera surveying the channel.

6. The method as claimed in claim 1, wherein the channel is filled completely with the first fluid after the pumping operation.

7. The method as claimed in claim 1, wherein the at least two chambers are emptied before the channel is purged with the second fluid, and wherein the first fluid remains in the channel after the at least two chambers have been emptied.

8. A computer program configured to execute a method of diluting, mixing, and/or aliquoting two fluids using a microfluidic system with at least two pump chambers connected to one another by at least one microfluidic channel, the at least one channel configured such that at least a portion of the first fluid remains in the channel after a pumping operation, the method includes:
filling at least one of the at least two pump chambers with a first fluid,
pumping the first fluid through the channel, leaving a portion of the first fluid in the channel,
ascertaining the portion of the first fluid remaining in the channel, and
purging the channel with a second fluid.

9. The computer program as claimed in claim 8, wherein the computer program is stored on a machine-readable storage medium.

10. An electronic control device configured to dilute, mix, and/or aliquot two fluids using a microfluidic system with at least two pump chambers connected to one another by at least one microfluidic channel, the at least one channel configured such that at least a portion of the first fluid remains in the channel after a pumping operation, the electronic control device configured to operate the microfluidic system to:
fill at least one of the at least two pump chambers with a first fluid,
pump the first fluid through the channel, leaving a portion of the first fluid in the channel,
ascertain the portion of the first fluid remaining in the channel, and
purge the channel with a second fluid.
